(19) United States
(12) Patent Application Publication
(10) Pub. No.: US 2010/0071149 A1
(43) Pub. Date: Mar. 25, 2010

(54) APPARATUS FOR RECEIVING CONSTRUCTION MATERIALS

(76) Inventor: Bobby Rich, Athens, GA (US)

Correspondence Address: Intellipex PLLC, 30200 Telegraph Road, Suite 245, Bingham Farms, MI, 48025, US

(21) Appl. No.: 12/560,464

(22) Filed: Sep. 16, 2009

Related U.S. Application Data
(60) Provisional application No. 61/192,623, filed on Sep. 19, 2008.

(51) Int. Cl. B65F 1/14

(52) U.S. Cl. 15/257.1

(57) ABSTRACT

One embodiment of an apparatus for receiving construction materials includes a base member, a pair of lateral sidewall members, a rear wall member, an elongated protruding member and an engagement structure. The pair of lateral sidewall members extends upwardly from a pair of lateral side portions of the base member. The rear wall member extends upwardly from a rear side portion of the base member. The base member, the pair of lateral sidewall members and the rear wall member configure a receptacle for receiving the construction materials. The elongated protruding member extends upwardly and outwardly at an angle from a front side portion of the base member, and is capable of scooping and collecting the construction materials from a ground surface into the receptacle. The engagement structure is mounted on a back side of the rear wall member for being detachably engaged with a power vehicle.

### CROSS-REFERENCE TO RELATED APPLICATIONS

This application claims the benefit of U.S. Provisional Application No. 61/192,623 filed on Sep. 19, 2008, the disclosure of which is incorporated by reference.

### FIELD OF THE DISCLOSURE

The present disclosure generally relates to apparatuses used at construction sites, and more particularly, to an apparatus for being used with power vehicles for receiving construction materials therein.

### BACKGROUND OF THE DISCLOSURE

Generally, power vehicles, such as skid steer loaders and the like, are used for hauling construction materials, such as debris, gravel, and the like, at construction sites. The skid steer loaders are rigid frame, engine-powered machines with lift arms used to attach a wide variety of labor-saving tools or attachments. The attachments may include conventional loader buckets, and the like. The conventional loader buckets may be utilized in conjunction with such power vehicles to receive the construction materials therein from the construction sites, and accordingly dump therefrom at a desired place.

Such a conventional loader bucket is generally small and may be incapable of receiving a large load of construction materials therein. Further, configuration of the conventional loader bucket may not be conducive to adequately collecting the construction materials from the ground level. Moreover, due to the configuration of the conventional loader bucket, some of the collected construction material may fall over during hauling by a power vehicle.

### SUMMARY OF THE DISCLOSURE

One embodiment of an apparatus for receiving construction material includes a base member, a pair of opposing lateral sidewall members, a rear wall member, an elongated protruding member, and an engagement structure. The base member includes a rear side portion, a front side portion and a pair of lateral side portions. The pair of lateral sidewall members extends upwardly from the pair of lateral sides portion of the base member. Further, the rear wall member extends upwardly from the rear side portion of the base member. The base member, the pair of lateral sidewall members and the rear wall member configure a receptacle for receiving the construction materials therein. Furthermore, the elongated protruding member extends upwardly and outwardly at an angle from the front side portion of the base member. The elongated protruding member is capable of scooping and collecting the construction materials from a ground surface into the receptacle. Moreover, the engagement structure mounted on a back side of the rear wall member is capable of being detachably engaged with a power vehicle.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a perspective view of one embodiment of an apparatus for receiving construction materials;

FIG. 2 is a back perspective view of the apparatus of FIG. 1; and

FIGS. 3 and 4 depict the apparatus of FIG. 1 being in utilized state in conjunction with a power vehicle.

Inventor: Rich, Bobby Utility Patent Application

Like reference numerals refer to like parts throughout the description of several views of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular apparatus for receiving construction materials, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The terms “a” and “an” herein do not denote a limitation of quantity, but rather denote the presence of at least one of the referenced item. Unless limited otherwise, the terms “mounted,” “coupled,” and variations thereof herein are used broadly and encompass direct and indirect attachments and arrangements.

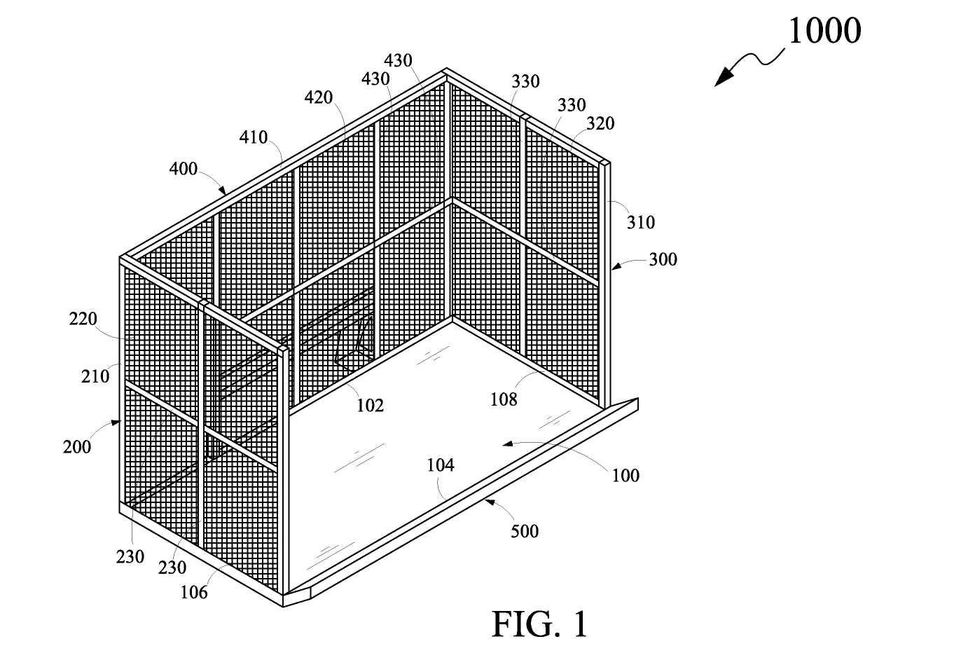

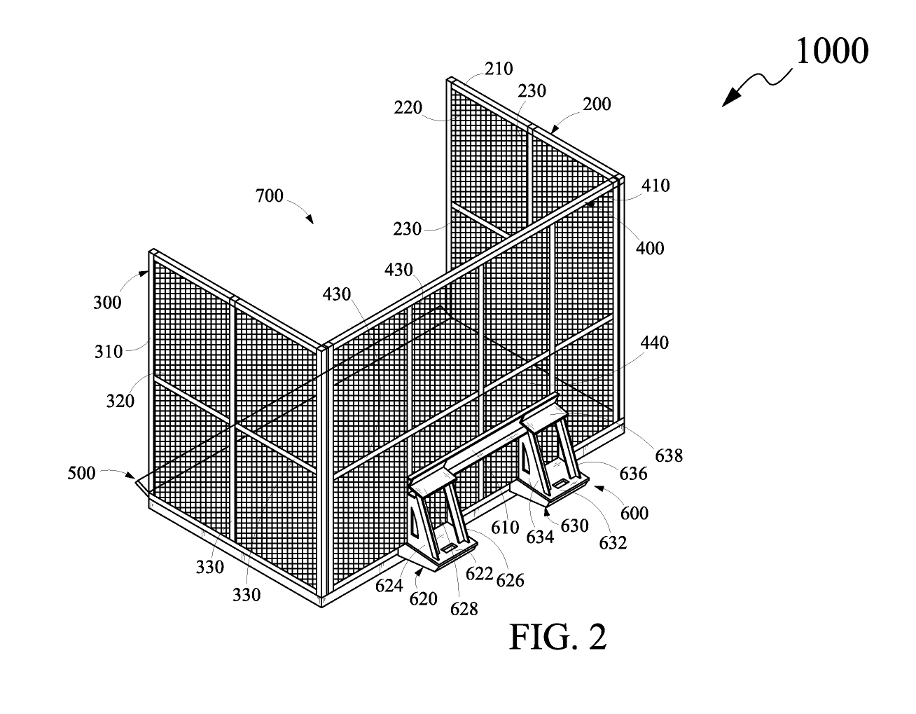

The present disclosure provides an apparatus for receiving construction materials. The term, “construction materials” as used herein relates to debris, gravel, and the like. Specifically, the apparatus is capable of being detachably engaged with a power vehicle for receiving the construction materials therein from construction sites, and accordingly dump therefrom at a desired place. The apparatus of the present disclosure is explained in detail in conjunction with FIGS. 1 and 2.

Referring to FIGS. 1 and 2, one embodiment of an apparatus 1000 includes a base member 100, a pair of opposing lateral sidewall members 200 and 300, a rear wall member 400, an elongated outwardly protruding member 500, and an engagement structure 600 (shown clearly in FIG. 2). The base member 100 includes a rear side portion 102, a front side portion 104, and a pair of opposing lateral side portions 106 and 108. In the present embodiment, the base member 100 is a flat metallic panel. Alternatively, the base member 100 may be a panel composed of any other suitable material, which is sufficiently rugged to withstand a load of the construction materials.

The pair of lateral sidewall members 200 and 300 lies opposite to each other and extends upwardly from the pair of lateral side portions 106 and 108, respectively. Each of the pair of lateral sidewall members 200 and 300 includes a framework and a mesh portion. As shown in FIGS. 1 and 2, the lateral sidewall member 200 includes a framework 210, and a mesh portion 220. Similarly, the lateral sidewall member 300 includes a framework 310, and a mesh portion 320. The frameworks 210 and 310 may be mounted on the pair of lateral side portions 106 and 108, respectively by a welding process and/or any suitable mechanical fastener. Examples of the mechanical fastener may include, but are not limited to, a nut and bolt fastener, and a snap-fit fastener. Further, the frameworks 210 and 310 may be obtained by a plurality of vertical and horizontal elongated metallic bars, such as metallic bars 230 and 330, respectively joined together by a welding process and/or by any suitable mechanical fastener. Alternatively, the frameworks 210 and 310 may be obtained by joining a plurality of vertical and horizontal elongated bars composed of any other suitable material. Furthermore, the mesh portions 220 and 320 are disposed on the frameworks 210 and 310, respectively. Specifically, the mesh portions 220 and 320 are coupled on the frameworks 210 and 310, respectively by a welding process and/or any suitable mechanical fastener. The mesh portions 220 and 320 may be perforated metallic sheets. Alternatively, the mesh portions 220 and 320 may be perforated sheets composed of any other material, which may withstand a load of the construction materials.

The rear wall member 400 extends upwardly from the rear side portion 102 of the base member 100 in between the pair of opposing lateral sidewall members 200 and 300. The rear wall member 400 may be joined with the rear side portion 102 and peripheral edge portions of the pair of lateral sidewall members 200 and 300 by a welding process and/or any suitable mechanical fastener. Similar to the pair of lateral sidewall members 200 and 300, the rear wall member 400 includes a framework 410 and a mesh portion 420. The framework 410, similar to the frameworks 210 and 310, may be obtained by a plurality of vertical and horizontal elongated metallic bars, such as metallic bars 430 joined together by a welding process and/or by any suitable mechanical fastener. The description of the rear wall member 400 having the framework 410 and the mesh portion 420 is not included herein for the sake of brevity. The base member 100, the pair of lateral sidewall members 200 and 300, and the rear wall member 400 collectively configure a receptacle 700 (as shown in FIG. 2) for receiving the construction materials therein. In an exemplary embodiment of the present disclosure, the apparatus 1000 may have a length of about 48 inches, a width of about 84 inches, and a height of about 48 inches. However, the dimensions of the apparatus 1000 may vary depending upon a manufacturer's preference.

The elongated protruding member 500 extends upwardly and outwardly at an angle from the front side portion 104 of the base member 100 (as shown in FIGS. 1 and 2). Specifically, the elongated protruding member 500 is attached in an inclined relation with the front side portion 104. The elongated protruding member 500 may be attached to the base member 100 by a welding process and/or any suitable mechanical fastener. In the present embodiment of the disclosure, the elongated protruding member 500 is a flat metallic plate. Alternatively, the elongated protruding member 500 may be a flat plate composed of any other suitable material. The elongated protruding member 500 is capable of scooping and collecting the construction materials from a ground surface into the receptacle 700.

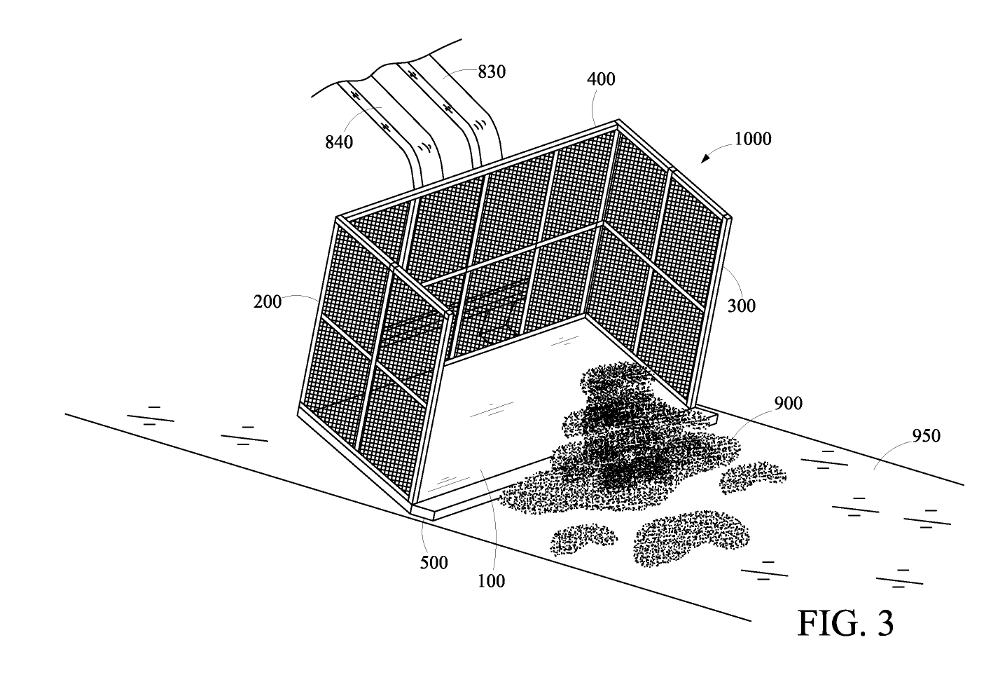

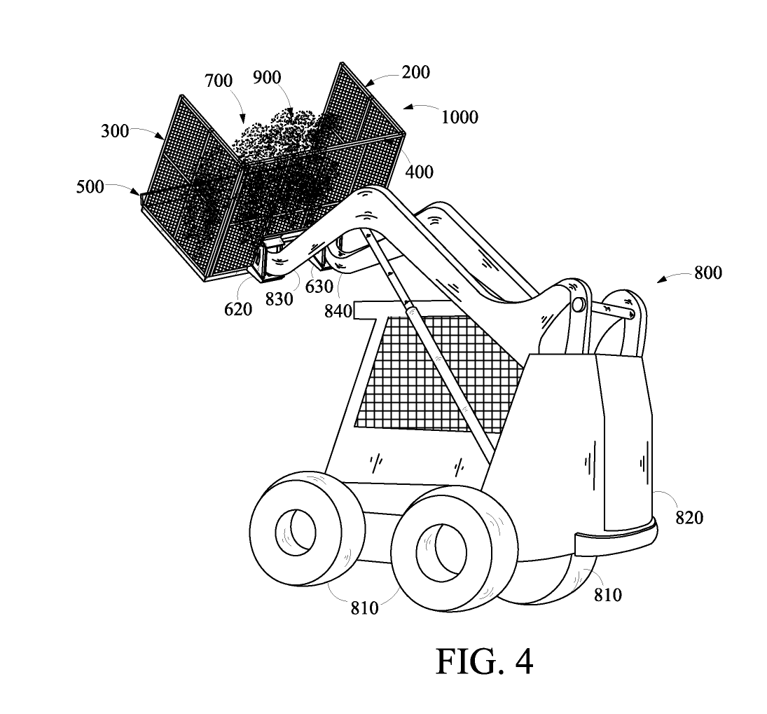

The engagement structure 600 is mounted on a back side 440 of the rear wall member 400 (shown clearly in FIG. 2). The engagement structure 600 includes a flange member 610 and a pair of slot members 620 and 630. The flange member 610 is disposed on the back side 440 of the rear wall member 400. The flange member 610 may be welded or attached by mechanical fasteners to the back side 440. The pair of slot members 620 and 630 is coupled to the flange member 610 in a spaced apart relation from each other. The flange member 610 and the pair of slot members 620 and 630 may be composed of metals. Alternatively, they may be composed of any other material. Further, each of the pair of slot members 620 and 630 includes a bottom portion, a pair of opposing lateral side portions mounted on the bottom portion, and a top portion mounted on the pair of opposing lateral side portions. As shown in FIG. 2, the slot member 620 includes a bottom portion 622, a pair of opposing lateral side portions 624 and 626, and a top portion 628 coupled together. Similarly, the slot member 630 includes a bottom portion 632, a pair of opposing lateral side portions 634 and 636, and a top portion 638 coupled together. The pair of slot members 620 and 630 is capable of being detachably engaged with handling arms of a power vehicle, as shown in FIGS. 3 and 4, for coupling the apparatus 1000 with the power vehicle to receive and dump the construction materials.

Referring now to FIGS. 3 and 4, one embodiment of the apparatus 1000 in utilized state in conjunction with a power vehicle 800 is shown. Herein, reference of FIGS. 1 and 2 will be taken to describe utility of the apparatus 1000 with the power vehicle 800. The power vehicle 800 includes a plurality of wheels 810, a body member 820 supported on the plurality of wheels 810, and a pair of handling arms 830 and 840 extending from the body member 820. For utilizing the apparatus 1000 with the power vehicle 800, the pair of arms 830 and 840 is engaged with the pair of slot members 620 and 630, respectively (as shown in FIGS. 3 and 4). The apparatus 1000 is then maneuvered by the power vehicle 800 to assume a horizontal orientation for receiving construction materials 900 therein (as shown in FIG. 3), and a vertical orientation for hauling the construction materials 900 to dump therefrom at a desired place (as shown in FIG. 4).

In the horizontal orientation of the apparatus 1000, the elongated protruding member 500 is capable of scooping and collecting construction materials from a ground surface 950 into the receptacle 700 (as shown in FIG. 3). Thereafter, the pair of arms 830 and 840 is maneuvered by the power vehicle 800 for enabling the apparatus 1000 to assume the vertical orientation.

In the vertical orientation, the construction materials 900 are protected from falling out from of the receptacle 700 from the three sides thereof that include the pair of opposing lateral sidewall members 200 and 300 and the rear wall member 400. There may be a possibility that the construction materials 900 may fall, prior to dumping, from the front open side of the apparatus 1000 while hauling in such vertical orientation. However, in such vertical orientation while hauling the apparatus 1000, the elongated protruding member 500 may prevent the construction materials 900 from falling out of the receptacle 700. At least, the elongated protruding member 500 may prevent the construction materials 900 lying at the front side portion 104 of the base member 100 from falling out of the receptacle 700. Moreover, upon reaching the dumping area, the construction materials 900 may be emptied from the apparatus 1000.

The present disclosure provides an apparatus, such as the apparatus 1000 for receiving the construction materials therein. The receptacle 700, collectively configured by the base member 100, the pair of opposing lateral sidewall members 200 and 300, and the rear wall member 400, may be adequate for receiving a large load of construction materials therein. Further, the elongated protruding member 500 may enable collection of the construction materials from ground level in an easy and time saving manner. Moreover, the elongated protruding member 500 may prevent the construction materials from falling over during hauling by a power vehicle 800.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teachings. The embodiments were chosen and described in order to best explain the principles of the present disclosure and its practical applications, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. An apparatus for receiving construction materials, the apparatus comprising:
a base member comprising a rear side portion, a front side portion and a pair of opposing lateral side portions;
a pair of opposing lateral sidewall members extending upwardly from the pair of lateral side portions of the base member;
a rear wall member extending upwardly from the rear side portion of the base member, wherein the base member, the pair of opposing lateral sidewall members and the rear wall member configure a receptacle for receiving the construction materials therein;
an elongated protruding member extending upwardly and outwardly at an angle from the front side portion of the base member, wherein the elongated protruding member is capable of scooping and collecting the construction materials from a ground surface into the receptacle; and
an engagement structure mounted on a back side of the rear wall member for being detachably engaged with a power vehicle.

2. The apparatus of claim 1, wherein the engagement structure comprises,
a flange member disposed on the back side of the rear wall member; and
a pair of opposing slot members coupled to the flange member in spaced apart relation from each other for being detachably engaged with the power vehicle.

3. The apparatus of claim 1, wherein the base member is a flat metallic panel.

4. The apparatus of claim 1, wherein the rear wall member comprises a framework, and a mesh portion disposed on the framework.

5. The apparatus of claim 4, wherein the mesh portion is composed of a perforated metallic sheet.

6. The apparatus of claim 4, wherein the framework is composed of metallic bars.

7. The apparatus of claim 1, wherein each of the pair of opposing lateral sidewall members comprises a framework, and a mesh portion disposed on the framework.

8. The apparatus of claim 7, wherein the mesh portion is composed of a perforated metallic sheet. bars.

9. The apparatus of claim 7, wherein the framework is composed of metallic

10. The apparatus of claim 1, wherein the elongated protruding member is a flat metallic plate.
